(19) United States
(12) Patent Application Publication
(10) Pub. No.: US 2012/0271477 A1
(43) Pub. Date: Oct. 25, 2012

(54) System And Method For Illumination Using Power Over Ethernet

(75) Inventors: Toru Okubo, Tokyo (JP); Gidi Lederer, Haifa (IL)

(73) Assignees: WIZLAN LTD., Tirat Carmel (IL); CYBER TRANS JAPAN CO., LTD., Tukio (JP)

(21) Appl. No.: 13/093,236

(22) Filed: Apr. 25, 2011

(51) Int. Cl. G06F 1/26

(52) U.S. Cl. 700/297

(57) ABSTRACT

An illumination system for energy efficiently illuminating locations e.g. offices, homes or ATM machine sites comprising a PoE switch supplying command and power to PoE-IP Illuminators, having energy-efficient LED light-sources. Using PoE+, light sources of over 20 Watts may be used. Each illuminator having a unique IP-ID is controllable over the PoE LAN. The system may include sensors and monitors such as: IP-camera, illumination sensors and entry detectors. At a remote ATM machine site, the system provides: illumination, voice assistance, surveillance security and banking. Renewable energy sources such as wind or solar power devices and rechargeable batteries allow pollution-free and remote location operation. Chainable IP-LED lights Daisy chained by a serial data channel and controlled by an IP-LED master connected to PoE line. The system may comprise PoE-IP controllers used for powering and controlling controlled devices capable of remotely controlled such as: Access devices, IP LED/electronic signs, shading, siren/alarms etc.

### FIELD OF THE INVENTION

The present invention relates to adding a fourth and fifth dimension to networking: adding lighting system and control devices to the common data, voice and video. Illumination and control systems providing both power and control signals over Ethernet.

### BACKGROUND OF THE INVENTION

With growing energy costs and the concern about the environment, there is a need to reduce electric power consumption.

In contrast to incandescent light bulbs and neon lamps, Light-Emitting Diode (LED) light source provides better energy-consumption/lamination ratio and longer operating/life time.

The efficiency and low consumption of LED lighting enables its connection and control as a common networking PoE/PD device (Power over Ethernet Powered Device).

Power over Ethernet (PoE) is commercially available and is used for powering small networking and IP devices such as computer peripherals such as IP phones, IP cameras, wireless access points, base stations etc. International protocols are available and define data and power transmission over the Ethernet lines.

### SUMMARY OF THE INVENTION

The present invention relates to adding a fourth and fifth dimensions to networking: adding lighting system and control systems to the common data, voice and video. Illumination system and control systems providing both power and control signals over standard Ethernet network infrastructure. In some embodiments, the system may comprise a PoE or PoE+ controller connected to a PoE or PoE+ switch and the controller is used for powering and controlling any device capable to be remotely controlled such as:
IP LED/electronic sign, to be used for example as programmable signs in building, office, ATM etc.
IP-controlled siren/alarms used in Emergency.
IP-controlled loudspeaker for providing instructions, direction or announcement etc.
IP-controlled access/lock controllers etc.
IP-controlled shading systems/motors etc.
Any other device capable to be remotely controlled.

“Lighting on the net” add another dimension for improving lighting efficiency and increasing power savings.

In the same context adding PoE/PD control systems, for example for shade control, entrance control, signs, alerts etc. will complete the network abilities to provide overall connection, power and control in service of the power savings and GREEN missions.

In an exemplary embodiment, an illumination and control system for energy efficiently illuminating locations such as offices, homes, as well as ticketing or ATM machine sites is provided.

The system comprises a PoE switch supplying both command and power to one or few PoE-IP Illuminators (PIPI) each having a high-power, energy efficient LED light sources, and to PoE-IP shading and entrance controllers. Using PoE 802.3af standards, light sources and control units of over 10 watts may be used with each PoE LAN cable. Using PoE+, light sources and control units of over 20 Watts may be used.

Each PIPI/controller has a unique IP-ID such and is controllable over the PoE LAN.

The system may include sensors and monitors such as an IP-camera, illumination sensors and entry detectors. At a remote ATM machine site, the system provides: illumination, voice assistance, surveillance security and banking. Renewable energy sources such as wind or solar power devices and rechargeable batteries allow pollution free operation and remote location operation.

Another aspect of the invention is to provide a system for PoE-IP controlling office and household devices and subsystems such as access points, room environment, door-locks, phones, wireless communication points, windows screens and shades, siren/alarm, LED/electronic signs and the likes using PoE-IP controllers.

Another aspect of the invention is to provide a PoE-IP Illuminator (PIPI). The PIPI comprises: a power/data separator, separating data and power received from a PoE LAN cable; a DC/DC circuit, converting separated power to voltage required to power controller; a controller, receiving data and controlling driver in response to said received separated data; a IP-ID non-volatile memory, providing IP-ID to said controller; a driver, receiving commands from said controller and controlling said separated power supplied to at least one LED light source; and at least one LED light source, producing illumination light.

In some embodiments the power/data separator, DC/DC circuit, controller, driver, and IP-ID non-volatile memory are integrated into a PoE-IP LED control module.

In some embodiments the power/data separator (420), DC/DC circuit, controller, driver, IP-ID non-volatile memory, and at least one LED light source are integrated into said PoE-IP Illuminator.

In some embodiments the PoE-IP Illuminator further comprising: at least one additional LED light source, receiving power from said driver; at least one additional power/data separator, receiving power from additional PoE LAN cable; and a power summing circuit, summing power from said power/data separator and from at least one additional power/data separator, and supplying summed power to said driver.

In some embodiments the PoE-IP Illuminator further comprising: at least one of: sensor input; or activation output.

In some embodiments the PoE switch is a PoE+.

In some embodiments the LED light source comprises a plurality of LED capable of using at least 8 Watt of power. In some embodiments the LED light source comprises a plurality of LED capable of using at least 15 Watt of power.

Another aspect of the current invention is to provide a PoE illumination system comprising: an IP-LED control server, connected to a PoE switch; a PoE switch, connected by Power over Ethernet LAN cable to at least one PoE-IP Illuminator, wherein said PoE-IP Illuminator is comprising: a power/data separator, separating data and power received from Power over Ethernet LAN cable; a DC/DC circuit, converting power to voltage required to power a controller; a controller, receiving data and controlling a driver in response to said received separated data; a IP-ID non-volatile memory providing IP-ID to said controller; a driver, receiving commands from said controller and controlling said separated power supplied to at least one light source; and at least one LED light source, producing illumination light.

In some embodiments the PoE illumination further comprises an LED management server.

In some embodiments the LED management server is located remotely from said PoE switch.

In some embodiments the PoE-IP Illuminator is further comprising: at least one additional LED light source, receiving power from said driver; at least one additional power/data separator, receiving power from additional Power over Ethernet LAN cable; and a power summing circuit, summing power from said power/data separator and from said at least one additional power/data separator, and supplying said summed power to said driver.

In some embodiments the PoE-IP Illuminator further comprises: at least one of: sensor input; or activation output.

In some embodiments the PoE switch is further comprising a rechargeable battery.

In some embodiments the PoE switch is powered by power sources such as: wind turbine, local generator, and solar power plant.

In some embodiments the illumination system is further comprising at least one of: at least one motion sensor such as an IP camera, connected to said PoE switch by a Power over Ethernet LAN cable; at least one illumination sensor, connected to said PoE switch by a Power over Ethernet LAN cable; and a wireless access point, connected to said PoE switch by a Power over Ethernet LAN cable.

In some embodiments the illumination system further comprises at least one hand-held device, interfacing wirelessly with said wireless access point, for controlling light emitted by said at least one LED light source.

It is another aspect of the current invention to provide a PoE illumination system for Automatic Teller Machine (ATM) site comprising: a Private Branch Exchange (PBX) server and a video server, connected by a network to a PoE switch; a PoE switch, connected by a PoE LAN cable to: at least one motion sensor such as an IP camera; an IP phone; an ATM machine; and at least one PoE-IP Illuminator, wherein said PoE-IP Illuminator comprises: a power/data separator, separating data and power received from a Power over Ethernet LAN cable; a DC/DC circuit, converting received separated power to voltage required to power controller; a controller, receiving separated data and controlling driver in response to said received separated data; a IP-ID non-volatile memory, providing IP-ID to said controller; a driver, receiving commands from said controller and controlling received separated power supplied to at least one LED light source; and at least one LED light source producing illumination light.

In some embodiments the PoE switch is further characterized by a rechargeable battery.

In some embodiments the PoE switch is powered by power sources such as: wind turbine, local generator, and solar power plant.

In some embodiments the PoE switch is further comprising a dry contact input.

In some embodiments the network is a wireless network.

It is yet another aspect of the current invention to provide a method of illumination, the method comprising: connecting a LED management server to a network; connecting a PoE switch to said network; connecting said PoE switch to a PoE LAN cable; connecting said PoE LAN cable to at least one PoE-IP illuminator, wherein said PoE illuminator is capable of: separating data from power transmitted by said PoE LAN cable; communicating a IP-ID to said LED management server; receiving and interpreting command from said PoE LAN cable; using said received commands for controlling a LED driver; driving at least one LED light source with said separated power using said controlled driver; and illuminating with light produced by said at least one LED light source.

In some embodiments the method of illumination further comprises: connecting at least one additional PoE LAN cable to said PoE illuminator; summing power received from said additional PoE LAN cable with power received by said PoE LAN cable; and providing said summed power to said LED driver.

It is another aspect of the current invention to provide a PoE illumination system comprising: an IP-LED control server, connected to a PoE switch; a PoE switch, connected by Power over Ethernet LAN cable to at least at least one, chain of chainable IP-LED lights, wherein said chain of chainable IP-LED light comprises: an IP-LED master connected via PoE line to said PoE switch; and a plurality of chainable IP-LED light, wherein each chainable IP-LED light comprises: a power supply, an LED light source; and an IP-LED Client, wherein said IP-LED clients are connected in a chain to said IP-LED master via a serial data channel, and said IP-LED Client controls the power supplied from said power supply to said LED light source in response to commands received via said serial data channel.

In some embodiments the system further comprises at least one room environment controller such as: motorized window screen, door lock, and personnel access point.

It is yet another aspect of the invention to provide a PoE control system comprising: an IP control server, connected to a PoE switch; a PoE switch, connected by Power over Ethernet LAN cable to at least one IP controller; at least one IP controller, receiving commands and power from said PoE switch over said PoE cable, and capable of powering and controlling at least one controlled device; and at least one remotely controlled device, controlled and powered by said IP controller, wherein said remotely controlled device is powered only by power supplied over said PoE cable.

In some embodiments the remotely controlled device is a remotely controlled device such as: an alarm; a siren; an announcement loudspeaker; a display; or an electronic sign.

In some embodiments the at least one remotely controlled device is a remotely controlled room environment controller such as: motorized window screen, door lock, and personnel access point.

The control system may further comprise illumination elements and/or other elements disclosed herein.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In case of conflict, the patent specification, including definitions, will control. In addition, the materials, methods, and examples are illustrative only and not intended to be limiting.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

The invention is capable of other embodiments or of being practiced or carried out in various ways. Also, it is to be understood that the phraseology and terminology employed herein is for the purpose of description and should not be regarded as limiting.

In discussion of the various figures described herein below, like numbers refer to like parts. The drawings are generally not to scale. For clarity, non-essential elements were omitted from some of the drawings. Some optional parts were drawn using dashed lines.

In the drawings:

FIG. 1 schematically depicts a PoE illumination system according to an exemplary embodiment of the current invention.

FIG. 2 schematically depicts a PoE illumination system with wireless and remote control according to another exemplary embodiment of the current invention.

FIG. 3 schematically depicts a PoE illumination system for ATM site according to another exemplary embodiment of the current invention.

FIG. 4 schematically depicts a block diagram of a PoE illumination device according to an exemplary embodiment of the current invention.

FIG. 5 schematically depicts a block diagram of a system for room environment control according to another exemplary embodiment of the current invention.

FIG. 6 schematically depicts a block diagram of a system for large room illumination according to another exemplary embodiment of the current invention.

### DESCRIPTION OF THE PREFERRED EMBODIMENTS

The present invention relates to an illumination system providing both power and control signals over Ethernet.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways.

To the extent that the figures illustrate diagrams of the functional blocks of various embodiments, the functional blocks are not necessarily indicative of the division between hardware circuitry. Thus, for example, one or more of the functional blocks (e.g., processors or memories) may be implemented in a single piece of hardware (e.g., a general purpose signal processor or random access memory, hard disk, or the like) or multiple pieces of hardware. Similarly, the programs may be stand alone programs, may be incorporated as subroutines in an operating system, may be functions in an installed software package, and the like. It should be understood that the various embodiments are not limited to the arrangements and instrumentality shown in the drawings.

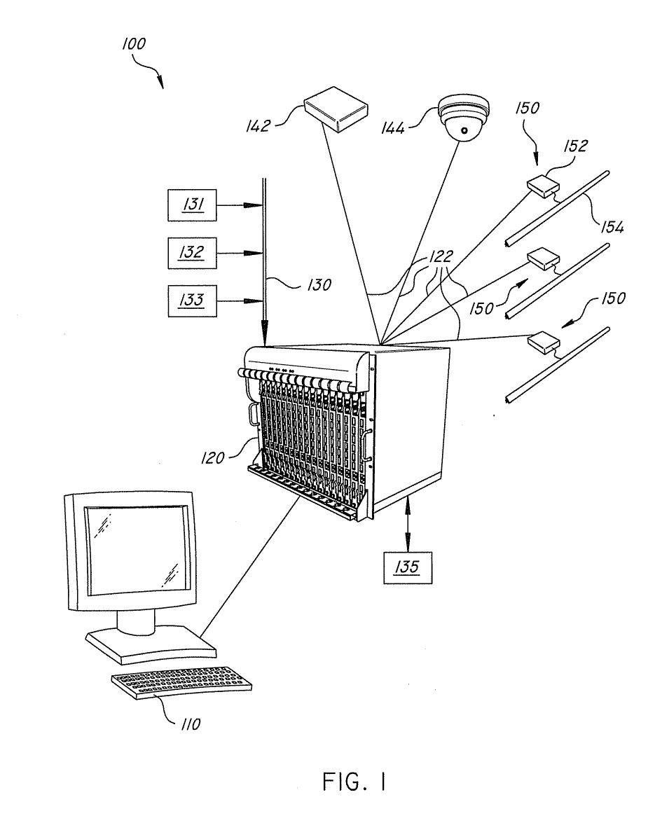

FIG. 1 schematically depicts a PoE illumination system 100 according to an exemplary embodiment of the current invention.

System 100 comprises a PoE switch 120 providing power and data exchange links to plurality peripherals devices via PoE Ethernet cables 122. For example, PoE switch 120 may be a PoE aggregation switch type CGS-806PPB, or the likes. For example PoE switch 120 may use IPv6 Ethernet standard. For example PoE standard IEEE 802.3AF) may be used, supplying 15 watts per channel, or PoE+ (IEEE 802.3AT) standard supplying 30 watts per channel, or other standards. PoE switch 120 is powered 130 for example by household main power grid. Additionally and optionally, PoE switch 120 may comprise internal power source such as a battery or rechargeable battery 135 to be used during power shortage or power failure such as during emergencies or fire. Additionally and optionally, PoE switch 120 may be powered by an Uninterruptable Power Supply (UPS) to be used during power outage.

Optionally, PoE switch 120 is powered by a renewable power source such as wind turbine 131, local generator 132, solar power plant 133 and the likes. When a renewable power source is used, electric grid may be used for backup and optionally to accept excess generated power. When the system is implemented without connection to the AC grid, for example at a remote areas, rechargeable battery 135 may be charged when power is available (during the day or when wind is blowing) and supply power when available power is insufficient. Optionally, rechargeable battery may be integrated within the PoE switch 120 as seen for example in U.S. patent application Ser. No. 12/855,445 filed on Aug. 12, 2010.

Using renewable power sources saves both operational cost and CO₂ and other pollutants emission, making system 100 an environmentally friendly or “Green” system.

PoE switch 120 is controlled by IP-LED control server 110 which executes controlling software allowing flexible control and configuration of the system. IP-LED control server 110 may be a computer such as a PC or a laptop computer. IP-LED control server 110 may be situated in proximity to PoE switch 120 or in a remote location. For example, one IP-LED control server 110 may control a plurality of PoE switches 120.

Light is provided by a plurality of PoE-IP Illuminator (PIPI)LED lights 150. Each PIPI 150 comprises a PoE-IP LED control module (PIL) 152 and LED light source or sources 154.

PIL 152 receives power from PoE switch 120, and control signals from-LED control server 110, and operates the LED light source or sources 154 according to the received commands.

LED light source 154 may be for example a single LED or preferably a plurality of LEDs packaged for example as a light tube or other array of LEDs. Light tubes are available for example in 1200 mm long requiring 22 Watt or 600 mm long requiring 11 Watt for its operation. With such low power requirements, and with high efficiency LED light sources, PoE lines 122 are capable of providing enough power for house or office illumination.

Other array of LED with higher or lower power requirement and consequently higher and lower illumination are available. It should be noted that LEDs may be integrated within the PIL 152 or be a separate component. Integrating the LED into the PIL 152 may allow packaging the entire PIPI 150 in a small sized device. However, keeping the LED light source 154 separate may allow using commercially available LED arrays, may allow replacement of defective LED, or may allow flexible use of light fixtures such as light reflectors or diffusers or decorative fixtures.

System 100 may further comprise sensors such as motion sensor 144 or illumination sensor 142. Sensors are typically powered by PoE switch 120 and provides IP-LED controller server 110 with information which may be used for determining illumination requirements.

For example, motion sensor 144 may be a PoE IP camera used for detecting presence of people in a room. PIPIs 150 would be turned off if the room is found to be not occupied.

Illumination sensor 142 may report the light level in the room such that PIPIs 150 are dimed or turned off when external light is available, for example sunlight during the day.

Other sensors may be used such as card entrance system to detect occupation of a room. Additionally or alternatively, a room may include manual controlling switch or dials allowing manual control of the lights in the room by manually operating these manual controlling switches.

It should be noted that commands to PIPIs 150 is transferred over the Local Area Network (LAN) cables 122, thus any computing device or devices connected to the LAN system, and having the access codes and IP addresses for operating PIPIs 150 may control the lights. For example, a user in the room, having a PC logged into the LAN system and having the required controlling software may use his PC for controlling the light in the room.

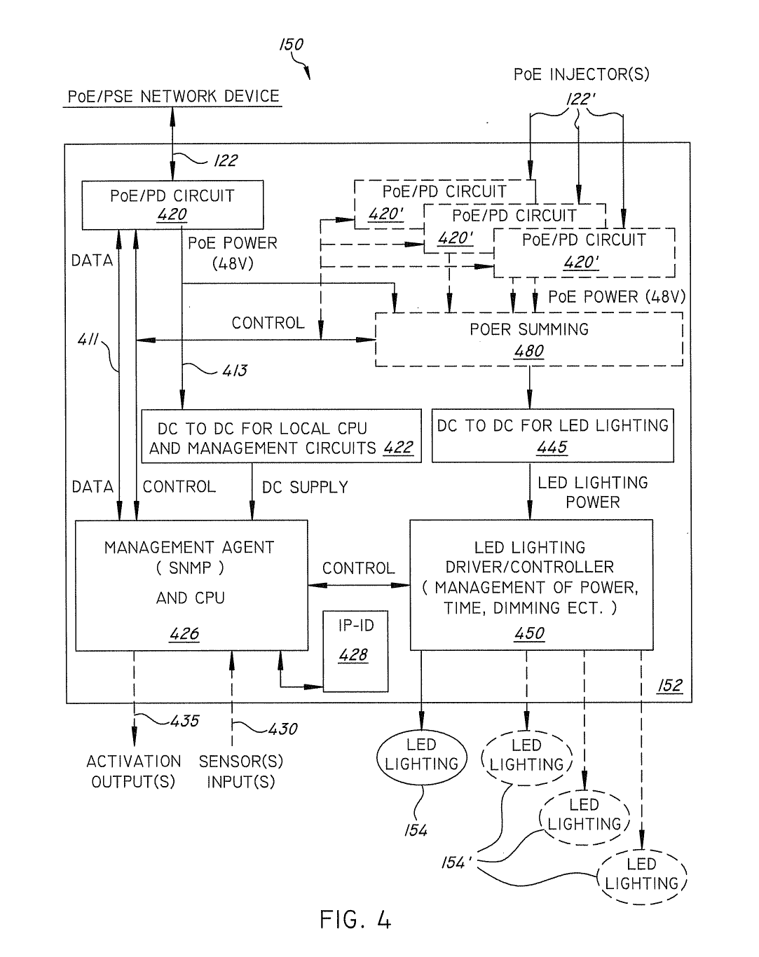

More details of the PIL 152 are given in FIG. 4.

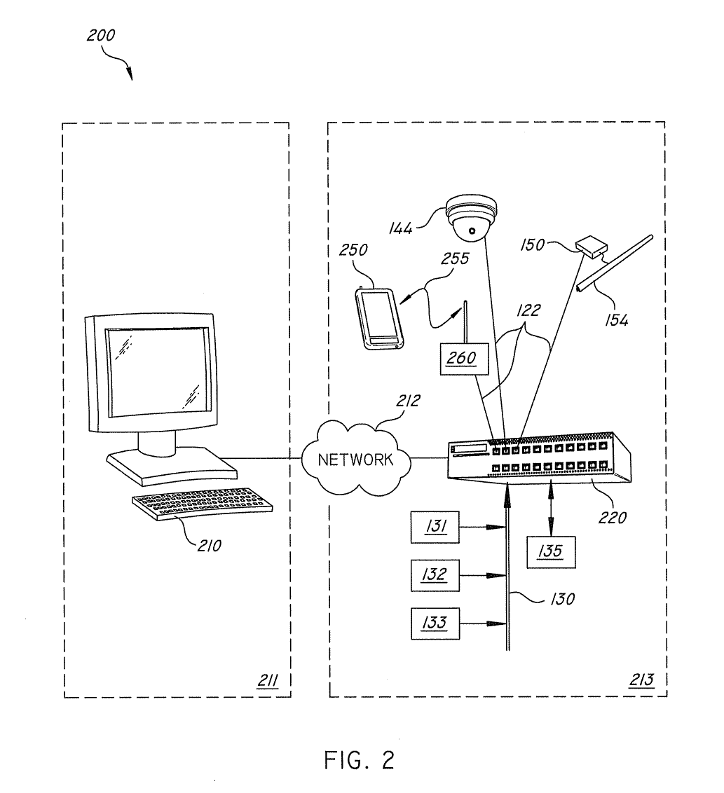

FIG. 2 schematically depicts a PoE illumination system 200 with wireless and remote control according to another exemplary embodiment of the current invention.

System 200 allows remote controlling of lights in room 213 from a LED management server 210 located in a remote location 211 and communicates over the network 212 with PoE switch 220 located in a separate location 213. For example, locations 213 and remote location 211 may be in two different buildings. Network 212 may be the Internet, allowing arbitrary distance between the two locations 211 and 213.

In the depicted embodiment PoE switch 220 may be a PoE switch such as CFS-809PB or the like. For PoE switch 220 may use IPv6 Ethernet standard.

PoE switch 120 is powered 130 for example by household main power grid. Additionally and optionally, PoE switch 120 may comprise internal power source such as a battery or rechargeable battery 135 to be used during power shortage or power failure such as during emergencies or fire. Additionally and optionally, PoE switch 120 may be powered by an Uninterruptable Power Supply (UPS) to be used during power outage. Optionally, PoE switch 120 is powered by a renewable power source such as wind turbine 131, local generator 132, solar power plant 133 and the likes. When a renewable power source is used, electric grid may be used for backup and optionally to accept excess generated power. When the system is implemented without connection to the AC grid, for example at a remote areas, rechargeable battery 135 may be charged when power is available (during the day or when wind is blowing) and supply power when available power is insufficient. Optionally, rechargeable battery may be integrated within the PoE switch 120

Additionally, optionally or alternatively, system 200 may allow wireless control of PIPIs. Wireless access point 260, connected to PoE switch 220 by cable 122 communicates wirelessly with hand-held device 250 over wireless channel 255.

Hand-held device 250 may be a smart phone such as Apple's iPhone, or Sony Ericson's XPERIA, and the likes. Hand-held device 250 may be another type of device such as Apple's iPod or iPad, and the likes. Preferably, wireless channel 255 is a short range RF communication channel such as Bluetooth or Wi-Fi, however Infra-Red (IR) communication may be used.

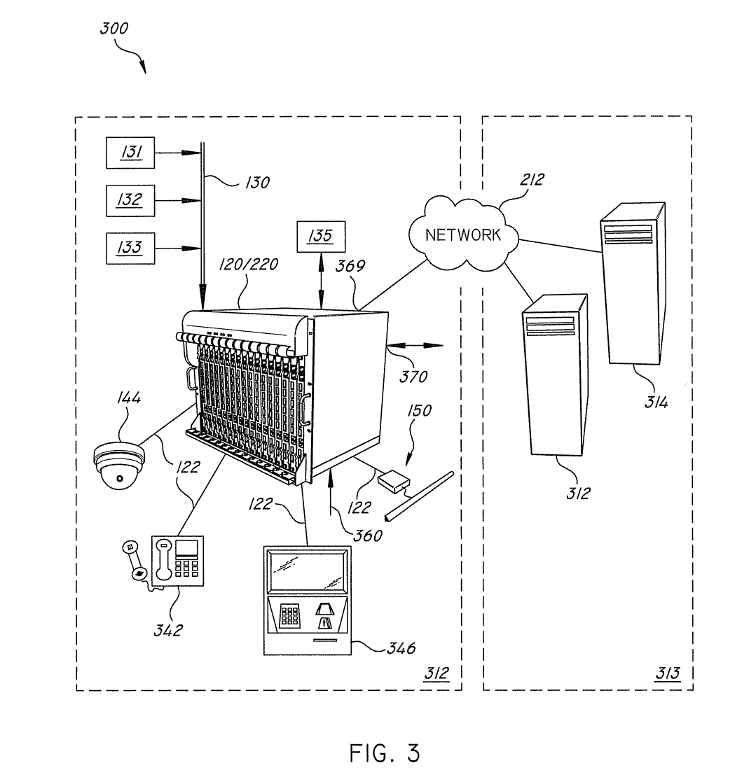

FIG. 3 schematically depicts a PoE illumination system 300 for Automatic Teller Machine (ATM) site 311 according to another exemplary embodiment of the current invention.

At the ATM site 311, a PoE switch 120 provides power to a security IP camera 144 and to at least one PIPI 150. Additionally, ATM site 311 may optionally include a Voice Over Internet Protocol (VoIP) phone 342, enabling the user to obtain audio assistance.

ATM machine 346 may require more power than can be provided by PoE switch 120 using PoE cable 122, and thus is optionally externally powered. However, additional power may be supplied by connecting more then one PoE cable 122 to the ATM machine 346. In some applications, ATM machine 346 is replaced or augmented by other machines such as vending machine, ticket issuing machine such as used in movie theaters, airports, railway stations, and the likes. At the remote site 313, Private Branch Exchange (PBX) server 314 and video server 312, which are connected to PoE switch 120 over the network 212 provides audio and video services respectively.

In some embodiments, network 212 comprises a wireless communication such as RF. Mobile, or satellite, communication. In these cases, a suitable modem (not seen in this figure) is used. In combination with local power source 132, or renewable power source 131 and/or 133 and energy storage 135, system 300 may be a stand alone system, remotely positioned without being connected to any infrastructure. In these cases, the low power consumption is of an advantage. In the depicted non-limiting exemplary embodiment, PoE switch 120 (or 220) is seen having two network ports: copper channel port 369 and optional fiber optic port 370.

An optional “dry contact” input 360 may be used for example for activation of system 300. For example an on/off switch, connected to input 360 may be configured to close when a user opens a door leading to an ATM booth, or by other sensor or switch indicating the need to operate system 300. This may trigger the system to exit “sleep mode” and to perform actions such as turning on the lights, activate or change the performance of the camera, activate the phone, issue an announcement, etc.

FIG. 4 schematically depicts a block diagram of a PIPI 150 according to an exemplary embodiment of the current invention.

PIPI 150 comprises a PIL 152 and at least one LED light source or source 154. PIL 152 is powered by PoE cable 122. In some embodiments, where high light power is desired, a plurality of LED's 154 is used, such as one or more additional LED's 154′ are used. In these cases, one or more additional PoE cables 122′ may be used.

In the PIL 152, data 411 is separated from 48 Volts power 413 at the power/data separator (PoE/PD) circuit 420. Some of the power is conditioned in the DC/DC circuit 422 for powering the Simple Network Management Protocol (SNMP) management and CPU controller 426. The SNMP communicates over LAN cable 122. Specifically, SNMP communicates its IP-ID number stored at IP-ID non-volatile memory 428. Additionally, SNMP may communicate over LAN cable 122 information such as LED status such as light out power, LED failures; Sensor's reading, etc.

In response to commands received over the LAN cable 122 and/or from optional local sensor (or sensors) via optional sensor input channel 430, controller 426 controls the LED lighting driver 450 to turn on or off, or to control the amount of light produced by LEDs 154.

Optionally, controller 426 may activate optional activation output or outputs 435 which may be used for controlling auxiliary devices such as power window shades, air-conditioning devices an the likes.

The part of power 413 is channeled to LED 154 and the optional additional LEDs 154′ via LED lighting driver/controller 450. If LED lighting driver/controller 450, the optional DC/DC LED power supply 445 converts the voltage to meet its specifications. However, some LED controllers may be made to use directly the voltage used in PoE standard. When additional PoE line or lines 122′ are used, each additional line is connected to a PoE/PD 420′. However, typically, only the main LAN line 122 carry data, while the additional line(s) 122′ are used for power injection only. In the case that additional PoE lines 122″ are used, a power summing circuit 480 is used to sum the power supplied from line 122 and additional line(s) 122′. It should be noted that other IP devices may be connected to systems 100, 200 and/or 300. Similarly, some devices may be replaced with equivalents or may be missing. For example, the systems may be used as a surveillance system comprising security devices such as cameras, motion sensors, entry sensors, identity verification devices, and the likes. Optionally, Infra-Red (IR) light LED is used for covert recording using IR sensitive camera.

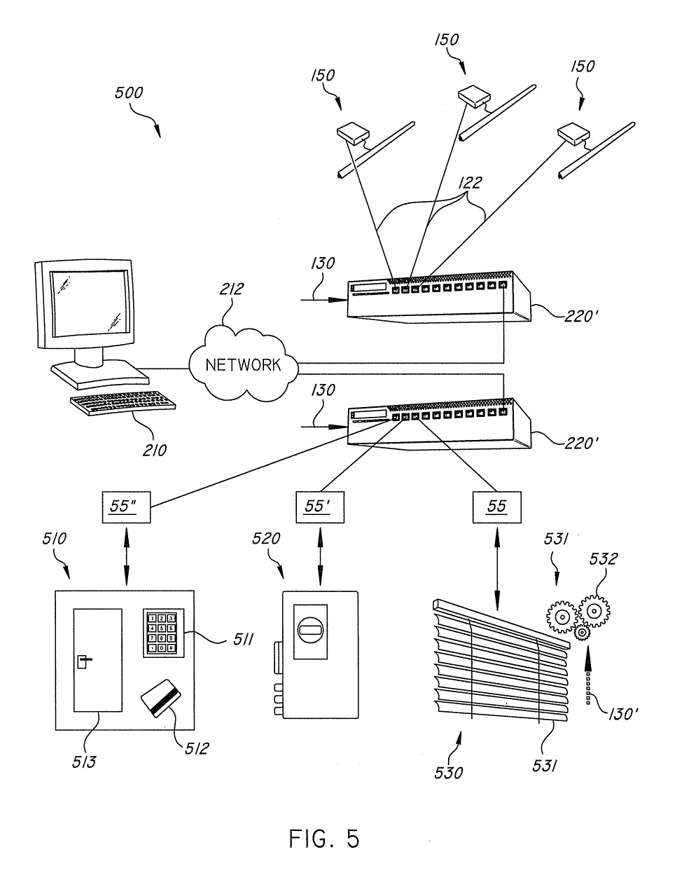

FIG. 5 schematically depicts a block diagram of a system 500 for room environment control according to another exemplary embodiment of the current invention.

System 500 may comprise one or a plurality of illumination PIPI 150 connected to PoE switch 220′. PoE switch 220′ is similar, identical or equivalent to other PoE switches already disclosed herein, or may be specifically tailored for the application, for example by comprising smaller number of channels, for example (but without limitation) four PoE or PoE+ ports. Additionally, PoE switches 220′ may optionally be configured to be connected in tandem, that is to be chained one to the other as well as being configured to be connected in “star” configuration as seen in this figure. In the depicted example, PoEs 220′ are powered 130 for example from main electrical grid, but may use other power sources as disclosed before.

System 500 may optionally comprise one or more room PoE/PD controls such as, but not limited to: electrically controlled window shade 530, door lock 520, security access point 510 and the like.

For example, electrically controlled window shade 530, may comprise screen 531, configured to be rolled up or down by a motorized rolling mechanism 532. Motorized rolling mechanism 532 may be powered by the PoE line 122 via controller 55, or may optionally be powered by optional power line 130′. Controller 55 may be PIL 152, controlling the screen 531 for example via activation output or outputs 435. Alternatively, a dedicated activation controller 55 may be used. An optional dedicated activation controller 55 may be constructed in which LED drivers 450 are replaced with drivers configured to drive the motorized rolling mechanism 532. In some embodiments, controller 55 may be integrated with motorized rolling mechanism 532.

For example, door lock 520 may be used for example to automatically open fire escape doors, or to be integrated with personnel access or monitoring system. Optional door lock 520 may optionally be powered externally or powered via PoE line 122. Controller 55′ may be PIL 152, controlling door 510 for example for example via activation output or outputs 435. Alternatively, a dedicated activation controller 55′ may be used. An optional dedicated activation controller 55′ may be constructed in which LED drivers 450 are replaced with drivers configured to drive door lock. In some embodiments, controller 55′ may be integrated within the door lock 520.

System 500 mat further comprise for example, security access point 510. Security access point 510 may be integrated with personnel access or monitoring system. Security access point 510 may comprise one or more of: a keypad 511, an RFID reader and an RFID card 512, and other security or biometric system 513. Security access point 510 may optionally be powered externally or powered via PoE line 122. Controller 55″ may be PIL 152 or a dedicated activation controller 55″ may be used.

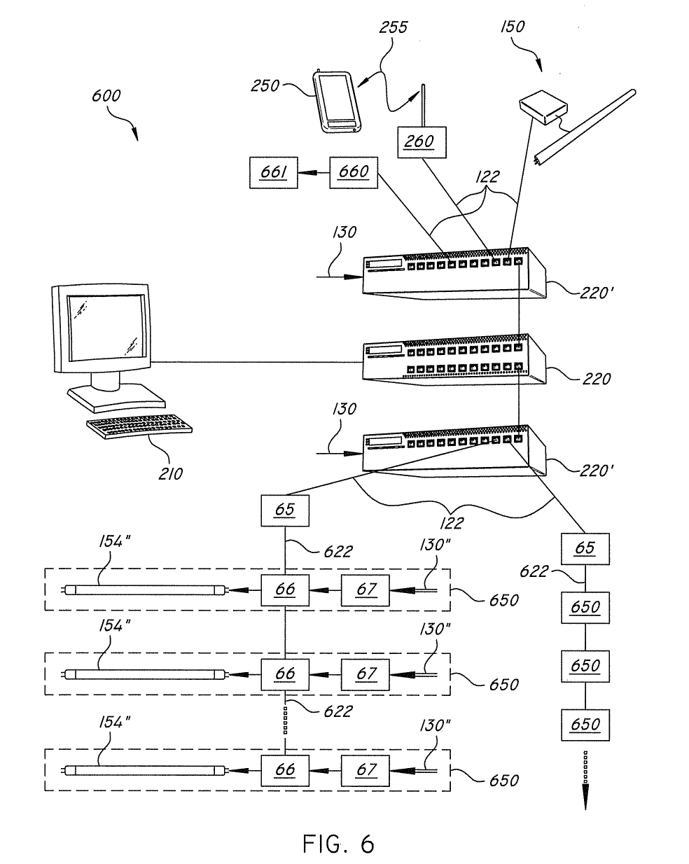

FIG. 6 schematically depicts a block diagram of a system 600 for large room illumination according to another exemplary embodiment of the current invention.

System 600 may optionally comprise one or a plurality of already disclosed devices such as, but without limitations, elements 220′ 150, 260 and 250.

Additionally, system 600 comprises at least one, and optionally a plurality of chains of chainable IP-LED lights 650. Each chain of chainable IP-LED light 650 is controlled by IP-LED master 65. IP-LED master 65 is connected via PoE line 122 to a PoE switch such as switch 220 or 220′. Each Chainable IP-LED light 650 comprises an IP-LED Clients 66, power supply 67, and at least one LED light source 154′.

IP-LED Clients 66 are daisy-chained via serial channels 622 connecting the first one to them to IP-LED master 65, and connecting them one to the next in the chain. Serial channel 622 may use standard infrastructure such as RJ11 lines and connectors. Optionally, up to 30 IP-LED Clients 66 may be connected in a chain, however shorter or longer chains may be used. Each IP-LED client 66 receives power from optional power supply 67 which is powered by power line 130″. Optional power supply 67 may be a transformer, an AC-DC supply or a DC to DC converter. Optionally power supply 67 may be integrated into IP-LED client 66 or missing. Each IP-LED client 66 controls at least one LED light source 154, similar or identical to LED light source or sources 154 already discloses.

Preferably, each IP-LED client 66 had a unique ID and receives and executes commands such as power on, power off, light level or light diming commands.

In some embodiments, the system such as system 100, 200, 300, 500 or 600 may also comprise a PoE or PoE+ controller 660 connected to a PoE or PoE+ switch such as switch 120, 220 or 220′. Controller 660 may in some option similar or identical to controller 152. Alternatively, controller 660 is different. Controller 660 is used for powering and controlling a controlled device 661. Controlled device 661 may be any device capable to be remotely controlled such as:
IP LED/electronic sign, to be used for example as programmable signs in building, office, ATM etc.
IP-controlled siren/alarms used in Emergency.
IP-controlled loudspeaker for providing instructions, direction or announcement etc.
IP-controlled access/lock controllers etc.
IP-controlled shading systems/motors etc.
Any other device capable to be remotely controlled.

The system is infinitely expandable using plurality of Ethernet switches. Additionally, central, cloud or distributed system monitoring, specific and statistical data collection, and control are possible. Authentication of system elements is possible using unique IDs.

It should be noted that the power available for powering the lights or other remotely controlled devices is limited by the power supplied by the PoE cable, or the plurality of cables to the IP controller, and in generally determined by the PoE standard used. Future PoE standards may provide higher or different power levels. Generally, the power consumed by the logic and control circuits in the IP controller are small, but need to be taken into account in determining the maximum power available for driving the useful loads.

As used herein, the term “CPU”, “Controller”, “computer” or “module” may include any processor-based or microprocessor-based system including systems using microcontrollers, reduced instruction set computers (RISC), application specific integrated circuits (ASICs), logic circuits, and any other circuit or processor capable of executing the functions described herein. The above examples are exemplary only, and are thus not intended to limit in any way the definition and/or meaning of the term “computer”.

The computer or processor executes a set of instructions that are stored in one or more storage elements, in order to process input data. The storage elements may also store data or other information as desired or needed. The storage element may be in the form of an information source or a physical memory element within a processing machine.

The set of instructions may include various commands that instruct the computer or processor as a processing machine to perform specific operations such as the methods and processes of the various embodiments of the invention. The set of instructions may be in the form of a software program. The software may be in various forms such as system software or application software. Further, the software may be in the form of a collection of separate programs or modules, a program module within a larger program or a portion of a program module. The software also may include modular programming in the form of object-oriented programming. The processing of input data by the processing machine may be in response to operator commands, or in response to results of previous processing, or in response to a request made by another processing machine.

As used herein, the terms “software” and “firmware” are interchangeable, and include any computer program stored in memory for execution by a computer, including RAM memory, ROM memory, EPROM memory, EEPROM memory, and non-volatile RAM (NVRAM) memory. The above memory types are exemplary only, and are thus not limiting as to the types of memory usable for storage of a computer program.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the various embodiments of the invention without departing from their scope. While the dimensions and types of materials described herein are intended to define the parameters of the various embodiments of the invention, the embodiments are by no means limiting and are exemplary embodiments. Many other embodiments will be apparent to those of skill in the art upon reviewing the above description. The scope of the various embodiments of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects.

Further, the limitations of the following claims are not written in means-plus-function format and are not intended to be interpreted based on 35 U.S.C. § 112, sixth paragraph, unless and until such claim limitations expressly use the phrase “means for” followed by a statement of function void of further structure.

This written description uses examples to disclose the various embodiments of the invention, including the best mode, and also to enable any person skilled in the art to practice the various embodiments of the invention, including making and using any devices or systems and performing any incorporated methods. The patentable scope of the various embodiments of the invention is defined by the claims, and may include other examples that occur to those skilled in the art. Such other examples are intended to be within the scope of the claims if the examples have structural elements that do not differ from the literal language of the claims, or if the examples include equivalent structural elements with insubstantial differences from the literal languages of the claims.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

1. A Power over Ethernet-Internet Protocol (PoE-IP) Illuminator comprising:
a power/data separator, separating data and power received from a PoE LAN cable;
a DC/DC circuit, converting said separated power to voltage required to power controller;
a controller, receiving data and controlling driver in response to said received separated data;
an IP-ID non-volatile memory, providing IP-ID to said controller;
a driver, receiving commands from said controller and controlling said separated power supplied to at least one LED light source; and
at least one LED light source, producing illumination light.

2. The PoE-IP Illuminator of claim 1, wherein said power/data separator, said DC/DC circuit, said controller, said driver, and said IP-ID non-volatile memory are integrated into a PoE-IP LED control module.

3. The PoE-IP Illuminator of claim 2, wherein said power/data separator, said DC/DC circuit, said controller, said driver, said IP-ID non-volatile memory, and said at least one LED light source are integrated into said PoE-IP Illuminator.

4. The PoE-IP Illuminator of claim 1, and further comprising:
at least one additional LED light source, receiving power from said driver;
at least one additional power/data separator, receiving power from at least one additional PoE LAN cable; and
a power summing circuit, summing power from said power/data separator and from at least one additional power/data separator, and supplying summed power to said driver.

5. The PoE-IP Illuminator of claim 1, and further comprising at least one of: sensor input; and activation output.

6. The PoE-IP Illuminator of claim 1, wherein said PoE LAN cable is a PoE+ LAN Cable.

7. The PoE-IP Illuminator of claim 6 wherein said LED light source comprises a plurality of LEDs capable of using at least 8 Watt of power.

8. A PoE illumination system comprising:
an IP-LED control server, connected to a PoE switch;
a PoE switch, connected by Power over Ethernet LAN cable to at least one PoE-IP Illuminator, wherein said PoE-IP Illuminator comprises:
a power/data separator, separating data and power received from Power over Ethernet LAN cable;
a DC/DC circuit, converting power to voltage required to power a controller;
a controller, receiving data and controlling a driver in response to said data;
an IP-ID non-volatile memory providing IP-ID to said controller;
a driver, receiving commands from said controller and controlling said power supplied to at least one light source; and
at least one LED light source, producing illumination light.

9. The PoE illumination of claim 8, and further comprising an LED management server.

10. The PoE illumination system of claim 9, wherein said LED management server is located remotely from said PoE switch.

11. The illumination system of claim 8, wherein said PoE-IP Illuminator is further comprising:
at least one additional LED light source, receiving power from said driver;
at least one additional power/data separator, receiving power from at least one additional Power over Ethernet LAN cable; and
a power summing circuit, summing power from said power/data separator and from said at least one additional power/data separator, and supplying said summed power to said driver.

12. The illumination system of claim 8, wherein said PoE-IP Illuminator further comprises at least one of: sensor input; or activation output.

13. The illumination system of claim 8, wherein said PoE switch is further comprising a rechargeable battery.

14. The illumination system of claim 13, wherein said PoE switch is powered by at least one power source selected from the group consisting of wind turbine, local generator, and solar power plant.

15. The illumination system of claim 8, and further comprising at least one of:
at least one sensor selected from the group consisting of a motion sensor, and an IP camera, connected to said PoE switch by a Power over Ethernet LAN cable;
at least one illumination sensor, connected to said PoE switch by a Power over Ethernet LAN cable; and
a wireless access point, connected to said PoE switch by a Power over Ethernet LAN cable.

16. The illumination system of claim 15, and further comprising at least one hand-held device, interfacing wirelessly with said wireless access point, for controlling light emitted by said at least one LED light source.

17. The illumination system of claim 8, and further comprising at least one controller connected to said PoE switch and controlling at least one remotely controlled device.

18. The illumination system of claim 17, wherein said at least one remotely controlled device is a remotely controlled device selected from the group consisting of an alarm; a siren; an announcement loudspeaker; a display; and an electronic sign.

19. A PoE illumination system for Automatic Teller Machine (ATM) site comprising:
a Private Branch Exchange (PBX) server and a video server, connected by a network to a PoE switch;
a PoE switch, connected by a PoE LAN cable to:
an IP camera;
an IP phone;
an ATM machine; and
at least one PoE-IP Illuminator, wherein said PoE-IP Illuminator comprises:
a power/data separator, separating data and power received from a Power over Ethernet LAN cable;
a DC/DC circuit, converting received separated power to voltage required to power controller;
a controller, receiving separated data and controlling driver in response to said received separated data;
an IP-ID non-volatile memory, providing IP-ID to said controller;
a driver, receiving commands from said controller and controlling received separated power supplied to at least one LED light source; and
at least one LED light source producing illumination light.

20. The PoE illumination system for Automatic Teller Machine (ATM) site of claim 19, wherein said PoE switch is further comprises a rechargeable battery.

21. The PoE illumination system for Automatic Teller Machine (ATM) site of claim 20, wherein said PoE switch is powered by power sources selected from the group consisting of wind turbine, local generator, and solar power plant.

22. The PoE illumination system for Automatic Teller Machine (ATM) site of claim 19, wherein said PoE switch further comprises a dry contact input.

23. The PoE illumination system for Automatic Teller Machine (ATM) site of claim 19, wherein said network is a wireless network.

24. A method of illumination comprising:
connecting a LED management server to a network;
connecting a PoE switch to said network;
connecting said PoE switch to at least one PoE LAN cable;
connecting said at least one PoE LAN cable to at least one PoE-IP illuminator, wherein said PoE illuminator is capable of:
separating data from power transmitted by said PoE LAN cable;
communicating an IP-ID to said LED management server;
receiving and interpreting command from said PoE LAN cable;
using said received commands for controlling a LED driver;
driving at least one LED light source with said separated power using said controlled driver; and
illuminating with light produced by said at least one LED light source.

25. The method of illumination of claim 24, an further comprising:
connecting at least one additional PoE LAN cable to said PoE illuminator;
summing power received from said additional PoE LAN cable with power received by said PoE LAN cable; and
providing said summed power to said LED driver.

26. A PoE illumination system comprising:
an IP-LED control server, connected to a PoE switch;
a PoE switch, connected by Power over Ethernet LAN cable to at least one chain of chainable IP-LED lights, wherein said chain of chainable IP-LED light comprises:
an IP-LED master connected via PoE line to said PoE switch; and
a plurality of chainable IP-LED light, wherein each chainable IP-LED light comprises:
a power supply,
an LED light source; and
an IP-LED Client, wherein said IP-LED clients are connected in a chain to said IP-LED master via a serial data channel, and said IP-LED Client controls the power supplied from said power supply to said LED light source in response to commands received via said serial data channel.

27. The PoE illumination system of claim 26 and further comprising at least one room environment controller selected from the group consisting of motorized window screen, door lock, and personnel access point.

28. A PoE control system comprising:
an IP control server, connected to a PoE switch;
a PoE switch, connected by Power over Ethernet LAN cable to at least one IP controller;
at least one IP controller, receiving commands and power from said PoE switch over said PoE cable, and capable of powering and controlling at least one controlled device; and
at least one remotely controlled device, controlled and powered by said IP controller, wherein said remotely controlled device is powered only by power supplied over said PoE cable.

29. The PoE control system of claim 28, wherein said at least one remotely controlled device is a remotely controlled device selected from the group consisting of an alarm; a siren; an announcement loudspeaker; a display; and an electronic sign.

30. The PoE illumination system of claim 28 wherein said at least one remotely controlled device is a remotely controlled room environment controller selected from the group consisting of motorized window screen, door lock, and personnel access point.
